(19) United States
(12) Patent Application Publication
(10) Pub. No.: US 2023/0294672 A1
(43) Pub. Date: Sep. 21, 2023

(54) CONTROL DEVICE, METHOD FOR OPERATING CONTROL DEVICE, AND NON-TRANSITORY COMPUTER-READABLE STORAGE MEDIUM

(71) Applicant: HONDA MOTOR CO., LTD., Tokyo (JP)

(72) Inventor: Daichi KATO, Wako-shi (JP)

(21) Appl. No.: 18/105,478

(22) Filed: Feb. 3, 2023

(30) Foreign Application Priority Data
Mar. 17, 2022 (JP) 2022-042373

(51) Int. Cl. B60W 30/09; B60W 30/095; B60W 30/18; B60W 50/16

(52) U.S. Cl. CPC B60W 30/09; B60W 30/0956; B60W 30/18163; B60W 50/16; B60W 2050/143

(57) ABSTRACT

A control device for controlling a vehicle comprising: a first sensor attached to a first position of the vehicle and that detects a first range including a side region of the vehicle; and a second sensor attached to a second position of the vehicle and that detects a second range including the side region, wherein at least a part of detection ranges of the first and second sensors overlap, and a partial region closer to the vehicle than an overlapping range is outside the detection range. The vehicle comprises: an estimation unit that estimates an obstacle position when the first/second sensor detects the obstacle in a lane adjacent to a travel lane of the vehicle and the obstacle enters a region outside the detection range; and a control unit that suppresses provision of a lane-change-assistance-function during estimation processing.

### CROSS-REFERENCE TO RELATED APPLICATION(S)

This application claims priority to and the benefit of Japanese Patent Application No. 2022-042373 filed on Mar. 17, 2022, the entire disclosure of which is incorporated herein by reference.

### BACKGROUND OF THE INVENTION

### Field of the Invention

The present invention relates to a control device, a method for operating the control device, and a non-transitory computer-readable storage medium.

### Description of the Related Art

Japanese Patent Laid-Open No. 2015-225615 discloses that, in lane change assistance, a vehicle that has entered a sensor blind area on the side of a self-vehicle is extrapolated by tracking, and the lane change assistance is resumed when a sensor cannot detect the vehicle again even after a certain period of time has elapsed.

However, in a case where the sensor cannot detect the vehicle even after a certain period of time has elapsed after extrapolation by tracking, when the lane change assistance is resumed, there is a possibility of collision in a case where an obstacle (including the vehicle) is actually present in the sensor blind area.

### SUMMARY OF THE INVENTION

The present invention has been made in view of the above problems, and provides a technique for improving safety of a lane change assistance function.

According to one aspect of the present invention, there is provided a control device for controlling a vehicle comprising: a first sensor that is attached to a first position of a vehicle and detects a first range including a side region of the vehicle; and a second sensor that is attached to a second position of the vehicle and detects a second range including the side region, wherein at least a part of detection ranges of the first sensor and the second sensor overlap each other, and a part of a region closer to the vehicle than an overlapping range is outside the detection range, and the vehicle comprises: an estimation unit configured to estimate a position of an obstacle when the first sensor or the second sensor detects the obstacle in an adjacent lane adjacent to a travel lane of the vehicle and the obstacle enters a region outside the detection range; and a control unit configured to suppress provision of a lane change assistance function during estimation processing by the estimation unit.

Further features of the present invention will become apparent from the following description of exemplary embodiments with reference to the attached drawings.

### BRIEF DESCRIPTION OF THE DRAWINGS

FIG. 1 is a block diagram of a vehicle and a control device;

FIG. 2 is an explanatory diagram illustrating types of driver assist modes and an outline thereof;

FIG. 3 is an explanatory diagram illustrating an example of switching the driver assist modes;

FIGS. 4A to 4C are flowcharts illustrating exemplary processing performed by the control device of FIG. 1;

FIG. 5 is a flowchart illustrating exemplary processing performed by the control device of FIG. 1;

FIG. 6 is an explanatory diagram of a relationship between a region of a detection range of a sensor and a region outside the detection range;

FIG. 7 is an explanatory diagram of a state in which another vehicle enters the region outside the detection range of the vehicle;

FIG. 8 is a flowchart illustrating exemplary processing performed by the control device of FIG. 1; and

FIG. 9 is an explanatory diagram of extrapolation processing.

### DESCRIPTION OF THE EMBODIMENTS

Hereinafter, embodiments will be described in detail with reference to the attached drawings. Note that the following embodiments are not intended to limit the scope of the claimed invention, and limitation is not made an invention that requires all combinations of features described in the embodiments. Two or more of the multiple features described in the embodiments may be combined as appropriate. Furthermore, the same reference numerals are given to the same or similar configurations, and redundant description thereof is omitted.

<Control Device and Application Example Thereof>

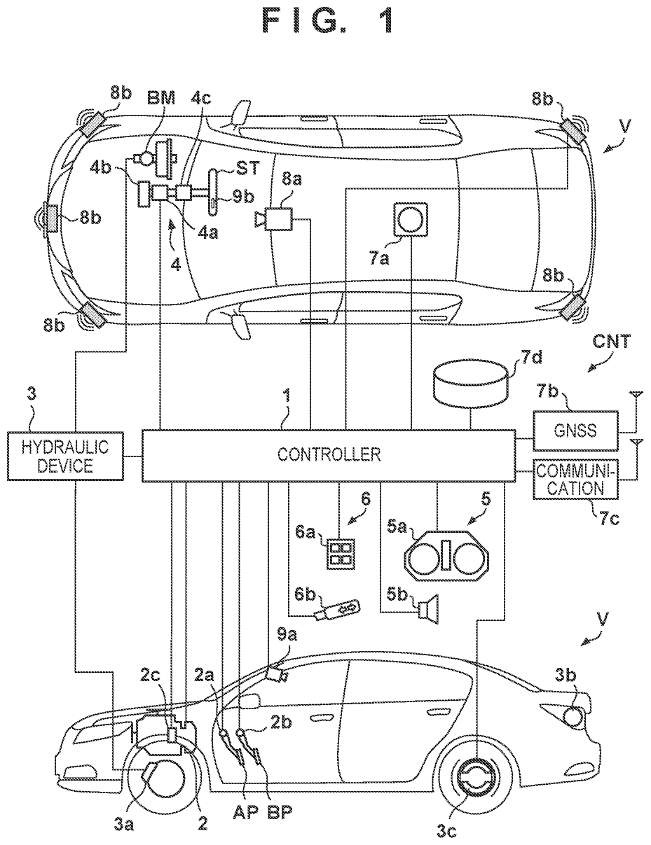

FIG. 1 is a block diagram of a control device CNT according to an embodiment of the present invention and a schematic diagram of a vehicle V as an application example thereof. In FIG. 1, an outline of the vehicle V is illustrated in a plan view and in a side view. The vehicle V of the present embodiment is, as an example, a sedan-type four-wheeled passenger car, and can be, for example, a parallel hybrid vehicle. Note that the vehicle V is not limited to the four-wheeled passenger car, and may be a straddle type vehicle (motorcycle or automatic three-wheeled vehicle) or a large vehicle such as a truck or a bus.

The control device CNT includes a controller 1 that is an electronic circuit that performs control of the vehicle V including driving assistance of the vehicle V. The controller 1 includes a plurality of electronic control units (ECUs). The ECU is, for example, provided for each function of the control device CNT. Each ECU includes a processor represented by a central processing unit (CPU), a storage device such as a semiconductor memory, an interface with an external device, and the like. The storage device stores a program to be executed by the processor, data to be used for processing by the processor, and the like. The interface includes an input/output interface and a communication interface. Each ECU may include a plurality of processors, storage devices, and interfaces. The program stored in the storage device may be stored in the storage device by being installed in the control device CNT using a non-transitory computer-readable storage medium such as a CD-ROM.

The controller 1 controls driving (acceleration) of the vehicle V by controlling a power unit (power plant) 2. The power unit 2 is a travel driving unit that outputs driving force for rotating driving wheels of the vehicle V, and can include an internal combustion engine, a motor, and an automatic transmission. The motor can be used as a drive source for accelerating the vehicle V, and can also be used as a generator at the time of deceleration or the like (regenerative braking).

In the case of the present embodiment, the controller 1 controls an output of the internal combustion engine or the motor or switches a gear ratio of the automatic transmission in accordance with a driving operation of a driver detected by an operation detection sensor 2a provided on an accelerator pedal AP or an operation detection sensor 2b provided on a brake pedal BP, a vehicle speed of the vehicle V detected by a rotation speed sensor 2c, or the like. Note that the automatic transmission is provided with the rotation speed sensor 2c that detects a rotation speed of an output shaft of the automatic transmission as a sensor that detects a traveling state of the vehicle V. The vehicle speed of the vehicle V can be calculated from a detection result of the rotation speed sensor 2c.

The controller 1 controls braking (deceleration) of the vehicle V by controlling a hydraulic device 3. A braking operation by the driver on a brake pedal BP is converted into hydraulic pressure in a brake master cylinder BM to be transmitted to the hydraulic device 3. The hydraulic device 3 is an actuator capable of controlling hydraulic pressure of a hydraulic oil supplied to a brake device 3a (for example, a disc brake device) provided on each of four wheels on the basis of the hydraulic pressure transmitted from the brake master cylinder BM.

The controller 1 can control braking of the vehicle V by performing drive control of an electromagnetic valve or the like included in the hydraulic device 3. In addition, the controller 1 can also configure an electric servo brake system by controlling distribution of a braking force by the brake device 3a and a braking force by the regenerative braking of the motor included in the power unit 2. The controller 1 may turn on a brake lamp 3b at the time of braking.

The controller 1 controls steering of the vehicle V by controlling an electric power steering device 4. The electric power steering device 4 includes a mechanism that steers front wheels in response to the driving operation (steering operation) of the driver on a steering wheel ST. The electric power steering device 4 includes a drive unit 4a that exerts driving force (may be referred to as a steering assist torque) for assisting the steering operation or automatically steering the front wheels of the vehicle V. The drive unit 4a includes a motor as a drive source. In addition, the electric power steering device 4 includes a steering angle sensor 4b that detects a steering angle, a torque sensor 4c that detects a steering torque (referred to as a steering load torque and is distinguished from the steering assist torque) borne by the driver, and the like.

The controller 1 controls an electric parking brake device 3c provided on a rear wheel of the vehicle V. The electric parking brake device 3c includes a mechanism for locking the rear wheel. The controller 1 can control locking and unlocking of the rear wheel by the electric parking brake device 3c.

The controller 1 controls an information output device 5 that notifies information to the inside of the vehicle. The information output device 5 includes, for example, a display device 5a that notifies the driver of the information by an image and/or a voice output device 5b that notifies the driver of the information by a voice. The display device 5a includes, for example, a display device provided on an instrument panel or a display device provided on the steering wheel ST. In addition, the display device 5a may include a head-up display. The information output device 5 may notify an occupant of the information by vibration or light.

The controller 1 receives an instruction input from the occupant (for example, the driver) via an input device 6. The input device 6 is disposed at a position operable by the driver, and includes, for example, a switch group 6a for the driver to instruct the vehicle V and/or a direction indicator lever 6b for operating a direction indicator (blinker).

The controller 1 recognizes and determines a current position and a course (an attitude) of the vehicle V. In the case of the present embodiment, the vehicle V is provided with a gyro sensor 7a, a global navigation satellite system (GNSS) sensor 7b, and a communication device 7c. The gyro sensor 7a detects a rotational motion (yaw rate) of the vehicle V. The GNSS sensor 7b detects the current position of the vehicle V. In addition, the communication device 7c performs wireless communication with a server that provides map information and traffic information, and acquires these pieces of information. In the case of the present embodiment, the controller 1 determines the course of the vehicle V on the basis of detection results of the gyro sensor 7a and the GNSS sensor 7b, and sequentially acquires map information on the course from the server via the communication device 7c to store the map information in database 7d (the storage device). Note that the vehicle V may be provided with another sensor for detecting the state of the vehicle V, such as an acceleration sensor for detecting acceleration of the vehicle V.

The controller 1 performs driving assistance of the vehicle V on the basis of detection results of various detection units provided in the vehicle V. The vehicle V is provided with surroundings detection units 8a and 8b which are external sensors that detect the outside (surrounding conditions) of the vehicle V, and vehicle interior detection units 9a and 9b which are vehicle interior sensors that detect conditions inside the vehicle (a state of the occupant (particularly the driver)). The controller 1 can grasp the surrounding conditions of the vehicle V on the basis of the detection results of the surroundings detection units 8a and 8b, and perform driving assistance according to the surrounding conditions. In addition, the controller 1 can determine whether the driver is performing a predetermined operational duty imposed on the driver when performing driving assistance on the basis of the detection results of the vehicle interior detection units 9a and 9b.

The surroundings detection unit 8a is an imaging device (hereinafter, may be referred to as a front camera 8a) that captures an image of the front of the vehicle V, and is attached to, for example, the vehicle interior side of a windshield at the front of a roof of the vehicle V. The controller 1 can extract a contour of a target or a lane marking (such as a white line) on a road by analyzing the image captured by the front camera 8a.

The surroundings detection unit 8b is a millimeter wave radar (hereinafter, may be referred to as a radar 8b), detects the target around the vehicle V using radio waves, and detects (measures) a distance to the target and a direction (an azimuth) of the target with respect to the vehicle V. In the example illustrated in FIG. 1, five radars 8b are provided, including one at the center of the front portion of the vehicle V, one at each of the left and right corner portions of the front portion, and one at each of the left and right corner portions of the rear portion.

Note that the surroundings detection unit provided in the vehicle V is not limited to the above configuration, and the number of cameras and the number of radars may be changed, or a light detection and ranging (LIDAR) for detecting the target around the vehicle V may be provided.

The vehicle interior detection unit 9a is an imaging device (hereinafter, may be referred to as an in-vehicle camera 9a) that captures an image of the inside of the vehicle, and is attached to, for example, the vehicle interior side at the front of the roof of the vehicle V. In the case of the present embodiment, the in-vehicle camera 9a is a driver monitor camera that captures an image of the driver (for example, eyes and a face of the driver). The controller 1 can determine a direction of line of sight or the face of the driver by analyzing an image (a face image of the driver) captured by the in-vehicle camera 9a.

The vehicle interior detection unit 9b is a grip sensor (hereinafter, may be referred to as a grip sensor 9b) that detects grip of the steering wheel ST by the driver, and is provided, for example, in at least a part of the steering wheel ST. Note that as the vehicle interior detection unit, the torque sensor 4c that detects the steering torque of the driver may be used.

<Example of Driving Assistance Control>

Examples of the driving assistance of the vehicle V for the driver include acceleration/deceleration assistance, lane keeping assistance, and lane change assistance. The acceleration/deceleration assistance is driving assistance (adaptive cruise control (ACC)) in which the controller 1 automatically controls the acceleration/deceleration of the vehicle V within a predetermined vehicle speed by automatically controlling the power unit 2 and the hydraulic device 3 on the basis of the detection result of the surroundings detection unit 8 and the map information. In the ACC, when there is a preceding vehicle, the acceleration/deceleration of the vehicle V can be performed so as to maintain an inter-vehicle distance from the preceding vehicle. The ACC reduces an operation burden of an acceleration/deceleration operation (an operation on the accelerator pedal AP or the brake pedal BP) by the driver.

The lane keeping assistance is driving assistance (lane keeping assist system (LKAS)) in which the controller 1 keeps the vehicle V inside a lane by automatically controlling the electric power steering device 4 on the basis of the detection result of the surroundings detection unit 8 and the map information. The LKAS reduces an operation burden of the steering operation (operation on the steering wheel ST) by the driver while the vehicle V is traveling straight.

The lane change assistance is driving assistance (auto lane changing (ALC), active lane change assist (ALCA)) in which the controller 1 changes a travel lane of the vehicle V to an adjacent lane by automatically controlling the power unit 2, the hydraulic device 3, and the electric power steering device 4 on the basis of the detection result of the surroundings detection unit 8 and the map information. The ALC is lane change assistance base on a system request (request from the control device), and the ALCA is lane change assistance based on an occupant request. An example of the system request is a case where a navigation system that provides route guidance to a destination of the vehicle V requests a lane change of the vehicle V. When making the occupant request, the driver instructs the lane change by operating the input device (for example, the direction indicator lever 6b). The ALC or the ALCA reduces the operation burden of the acceleration/deceleration operation and the steering operation of the vehicle V by the driver at the time of lane change.

Note that other examples of driving assistance control may include a collision reduction brake that assists collision avoidance with the target (for example, an obstacle (a pedestrian, another vehicle, and the like can also be included)) on the road by controlling the hydraulic device 3, an ABS function, traction control, and/or posture control of the vehicle V.

<Driver Assist Mode>

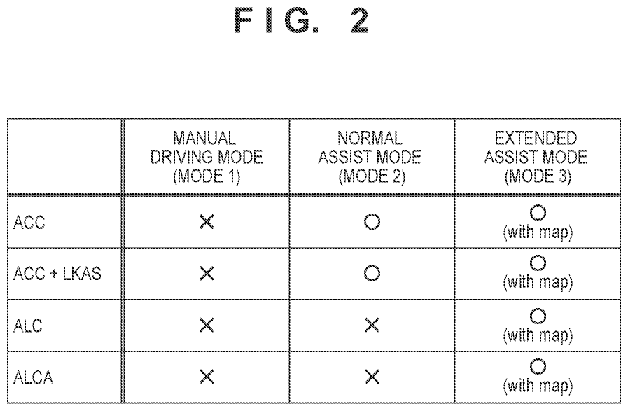

In the case of the present embodiment, one mode is selectively set among a plurality of modes having different driving assistance contents. FIG. 2 is an explanatory diagram of thereof. Here, relationships between three types of modes 1 to 3 and execution feasibility of the ACC, the LKAS, the ALC, and the ALCA are illustrated. The driving assistance content in each mode 1 to 3 is not limited to the ACC, the LKAS, the ALC, or the ALCA, and may include other driving assistance content. In addition, only one of the ALC and the ALCA may be used.

The mode 1 is a manual driving mode in which none of the ACC, the LKAS, the ALC, and the ALCA is performed, and is a mode based on a manual driving operation of the driver. This mode is a mode set first when the vehicle V is activated.

The mode 2 and the mode 3 are modes set on condition that the occupant makes a driving assistance instruction in the mode 1. The mode 2 is a normal assist mode that can be performed by the ACC and the LKAS. In the mode 2, the ALC and the ALCA are not performed.

The mode 3 is an extended assist mode in which all of the ACC, the LKAS, the ALC, and the ALCA can be performed. The mode 3 is a mode on the assumption that the controller 1 has obtained high-precision map information including information on a road (travel path) on which the vehicle V travels. The high-precision map information is map information having more accurate information about road information than map information (may be referred to as normal map information) used for the route guidance to the destination. Specifically, at least position information in the lane is included. This can be used to control the position of the vehicle V in the vehicle width direction. A high-precision map may be used that further includes information on a detailed shape of the road, such as presence or absence of a curve, curvature, increase or decrease of the lane, and gradient. The high-precision map information is, for example, prepared for each region or road section, and there can be a region or road section for which the high-precision map information is not provided. Note that, in the mode 3, the ALC and the ALCA are performed in principle when there is the high-precision map information, but on the other hand, for example, when the processing can be performed with technical progress or time, it may be configured such that the ALC and the ALCA can be performed using information of a normal navigation map instead of the high-precision map. That is, it may be configured such that the ALC and the ALCA can be performed even in the mode 2.

In the mode 3, the lane change assistance (ALC and ALCA) is performed using the high-precision map information. By utilizing the position information in the lane included in the high-precision map information and the current position of the vehicle V detected by the GNSS sensor 7b, it is possible to perform highly reliable and smooth lane change assistance while recognizing other vehicles in the vicinity from external detection results of the detection units 8a and 8b. The lane change assistance can be performed without using the high-precision map information, but if there is a difference in behavior of the vehicle V at the time of lane change assistance between a case where the high-precision map information is used and a case where the high-precision map information is not used, the driver may feel discomfort. In the present embodiment, by performing the lane change assistance on the premise of obtaining the high-precision map information, it is possible to prevent such discomfort from being given to the occupant and to provide the occupant with highly reliable lane change assistance.

Both the mode 2 and the mode 3 are modes capable of performing the ACC and the LKAS, but in the mode 3, the ACC and the LKAS using the high-precision map information can be performed. In terms of using the high-precision map information, the ACC and the LKAS in the mode 3 are respectively represented as the ACC with map and the LKAS with map. The controller 1 can take the road information of travel destination of the vehicle V from the high-precision map information in advance to perform the acceleration/deceleration of the vehicle V and position control in a left-and-right direction, and can provide the occupant with more reliable and smooth ACC and LKAS.

Note that in the present embodiment, in both the mode 2 and the mode 3, the driver is requested to perform predetermined operational duties such as peripheral monitoring and gripping of the steering wheel. When it is determined that the driver does not perform the predetermined operational duties on the basis of the detection results of the vehicle interior detection units 9a and 9b, the information output device 5 performs notification (warning) for prompting the driver to perform the predetermined operational duties.

<Transition Example of Mode Setting>

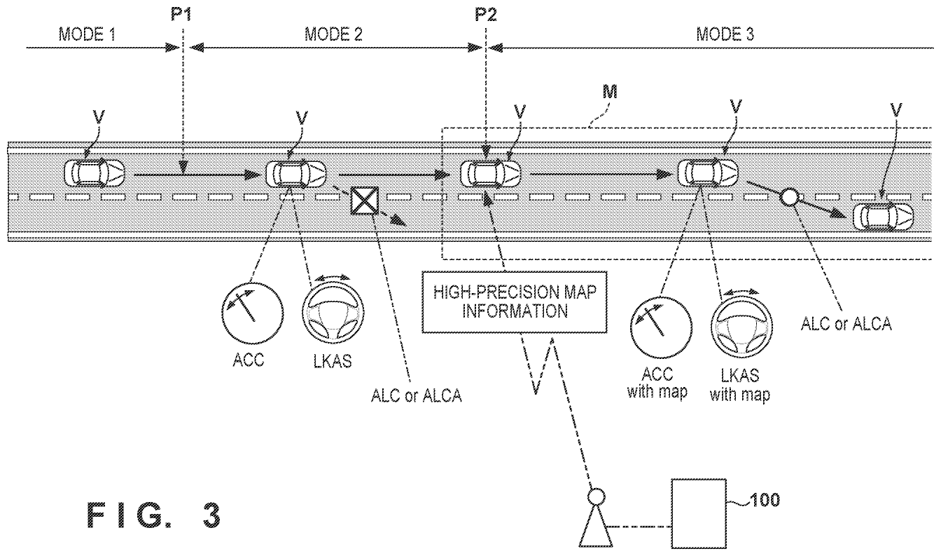

FIG. 3 is a diagram illustrating a transition example of the driver assist mode. While the vehicle V is traveling in the mode 1, when the driver makes the driving assistance instruction via the input device 6 at a position P1, the mode 2 is set. The controller 1 performs ACC control and LKAS control of the vehicle V. As indicated by a cross mark in the figure, ALC control and ALCA control of the vehicle V are not performed. When the driver wishes to change lanes, the lane change is performed by the driver's own driving operation.

The road (travel path) on which the vehicle V travels is a road on which the high-precision map information is provided in a section M. The controller 1 obtains (receives) the high-precision map information of the section M from a map providing server 100 via a communication line by the communication device 7c at a position P2. Thus, the driver assist mode is switched from the mode 2 to the mode 3. The controller 1 performs the ACC control and the LKAS control using the high-precision map information. In addition, the ALC control or the ALCA control is performed in response to the system request or the occupant request as indicated by a circle mark in the figure.

<Exemplary Processing>

Exemplary processing performed by the processor of the ECU constituting the controller 1 will be described.

<Operation Duty Monitoring>

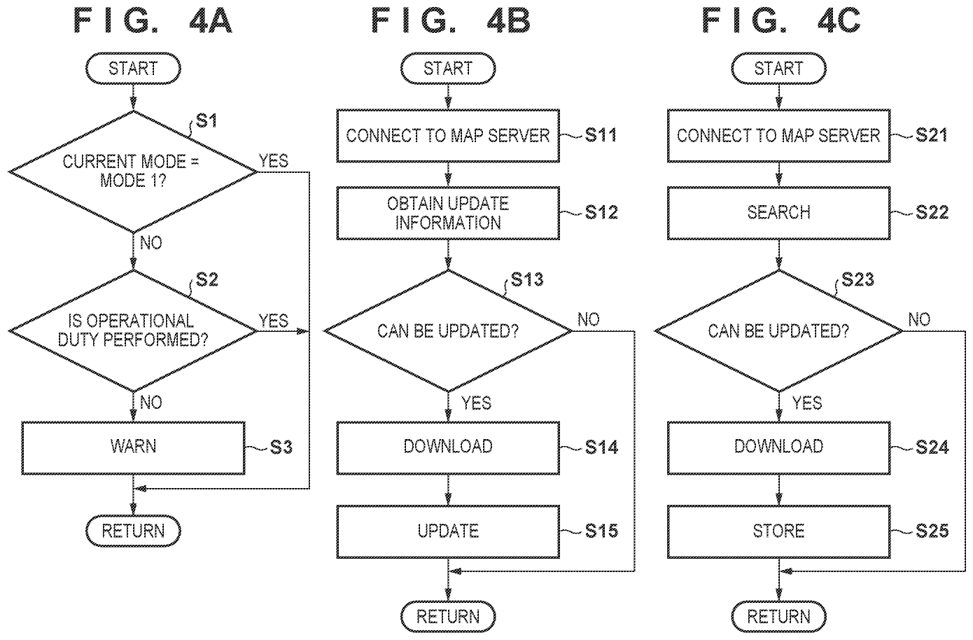

FIG. 4A is a flowchart illustrating exemplary processing performed by the ECU that monitors the operational duty of the driver, and the processing is periodically performed.

In S1, it is determined whether the current driver assist mode is the mode 1. If the current driver assist mode is the mode 1, the processing is ended, and if the current driver assist mode is the mode 2 or the mode 3, the process proceeds to S2. In S2, it is determined whether the driver performs the operational duty on the basis of the detection results of the detection units 9a and 9b. If it is determined that the operational duty is performed, the processing is ended, and if it is determined that the operational duty is not performed, the process proceeds to S3. In S3, the information output device 5 warns the driver.

<Management of High-Precision Map Information>

FIGS. 4B and 4C are flowcharts illustrating exemplary processing performed by the ECU that manages the high-precision map information. FIG. 4B illustrates exemplary processing related to update (data update) of the obtained high-precision map information, and the processing is performed, for example, when the vehicle V is started.

In S11, the communication device 7c connects to the map providing server 100 and starts communication with the map providing server 100. In S12, update information (latest version information) of each piece of the high-precision map information is obtained (received) from the map providing server 100. In S13, it is determined whether the obtained high-precision map information can be updated to the latest version. In this determination, it is determined whether the latest version of the obtained high-precision map information is provided and there is a qualification (for example, a provision contract of the map, charging, and the like) to receive the provision. When the information can be updated, the process proceeds to S14, and the updated map data of the latest version of the high-precision map information is downloaded from the map providing server 100. In S15, the obtained high-precision map information is updated by the updated map data obtained in S14. Thus, the high-precision map information can be maintained in the latest state.

FIG. 4C is the processing while the vehicle V is traveling, and is processing performed when the vehicle V is traveling on a road for which the high-precision map information is not obtained or when the vehicle V is about to enter the road for which the high-precision map information is not obtained.

In S21, the communication device 7c connects to the map providing server 100 and starts the communication with the map providing server 100. In S22, the map providing server 100 is requested to search for the high-precision map information including information on the travel path of the vehicle V or a road on which the vehicle V is scheduled to travel, and a response is obtained. In S23, it is determined whether it is possible to obtain the high-precision map information including the information on the travel path of the vehicle V or the road on which the vehicle V is scheduled to travel. In this determination, it is determined whether the high-precision map information requested to be searched has been provided and there is the qualification (for example, the provision contract of the map, charging, and the like) to receive the provision. When the information can be obtained, the process proceeds to S24, and the high-precision map information requested to be searched is downloaded from the map providing server 100. In S25, the high-precision map information obtained in S24 is stored in the database 7d. This makes it possible to set the mode 3.

<Mode Setting>

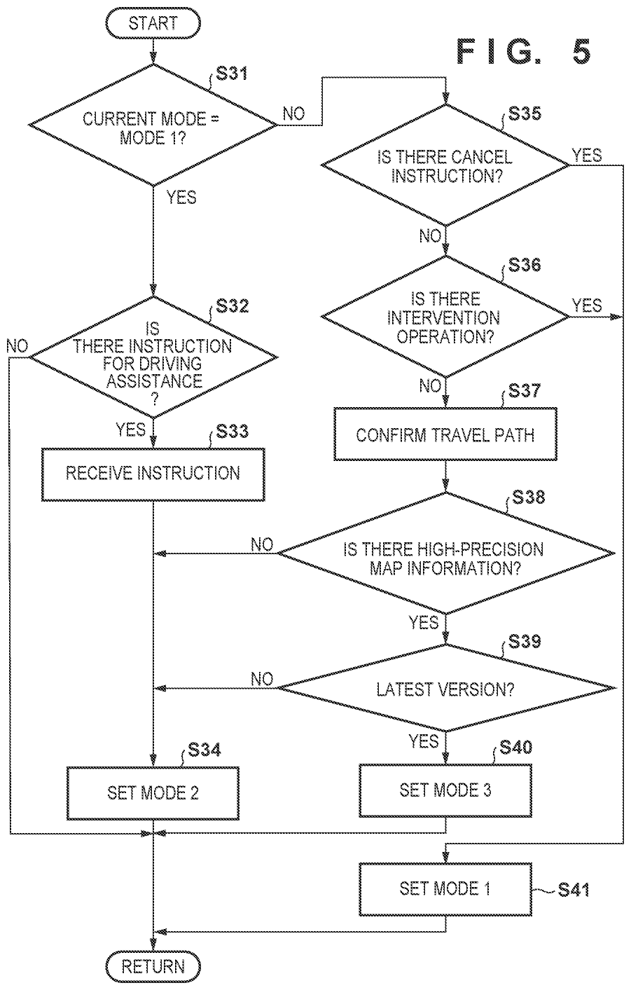

FIG. 5 is a flowchart illustrating exemplary processing performed by the ECU that sets the driver assist mode, and the processing is periodically performed. In S31, it is determined whether the current mode is the mode 1. If the current mode is the mode 1, the process proceeds to S32, and if the current mode is the mode 2 or the mode 3, the process proceeds to S35.

In S32, it is determined whether a start instruction for driving assistance has been made from the driver. The driver can make the start instruction via the input device 6. When an instruction operation is performed on the input device 6, the start instruction for driving assistance is received in S33, and the mode 2 is set in S34. In S35, it is determined whether a cancel instruction for driving assistance has been made. The driver can make the cancel instruction via the input device 6. If the cancel instruction has been made, the mode 1 is set in S41, and if the cancel instruction has not been made, the process proceeds to S36.

In S36, it is determined whether an intervention operation has been performed by the driver. The intervention operation is the acceleration/deceleration operation and the steering operation of the driver during driving assistance, and is detected by the operation detection sensors 2a and 2b, the steering angle sensor 4b, and the torque sensor 4c. When such an operation reaches a certain amount of time or a certain amount of operation, it is assumed that the driver intends manual driving, the mode 1 is set in S41, and control is performed so that driving of the vehicle V is entrusted to the driver. If there is no intervention operation, the process proceeds to S37.

In S37, the travel path of the vehicle Vis specified on the basis of a detection result of the GNSS sensor 7b and the normal map information or the high-precision map information. In S38, it is determined whether the high-precision map information including the information on the travel path specified in S37 has been obtained, and if the high-precision map information has not been obtained, the process proceeds to S34 and the mode 2 is set. When the high-precision map information has been obtained, the process proceeds to S39, and it is determined whether the high-precision map information is the latest version. Whether it is the latest version is determined on the basis of the update information obtained in S12 of FIG. 4B. If it is not the latest version, there is a possibility that quality of driving assistance in the mode 3 will be deteriorated, and thus the mode 2 is set in S34. If it is the latest version, the mode 3 is set in S40.

In the present embodiment, when the driving assistance instruction from the occupant is received in S33, unless the mode 1 is set, the mode 2 or the mode 3 is set without requiring the driving assistance instruction again. That is, the driving assistance instruction is a condition of the mode 1 to the mode 2, but is not a condition of the mode 2 to the mode 3.

Therefore, for example, after the mode 3 is set, there is a case where the mode 2 is set due to traveling on a road having no high-precision map information (S38 and S34), but when the high-precision map information is obtained after traveling in the mode 2, the mode 3 is set without requiring re-reception of the driving assistance instruction from the occupant (S38 and S40), and the ALC and the ALCA can be provided to the driver. Therefore, the driver is not required to repeatedly make the driving assistance instruction, and it is possible to prevent the instruction operation from giving a complicated feeling.

On the other hand, even if the mode 2 or the mode 3 is being set, if the intervention operation is performed, the mode 1 is set (S36 and S41). In this case, the driving assistance instruction is required again in order to set the mode 2 or the mode 3. It is possible to reliably confirm the driver's intention concerning provision of driving assistance.

<Description of Detection Range of Sensor and Region Outside Detection Range>

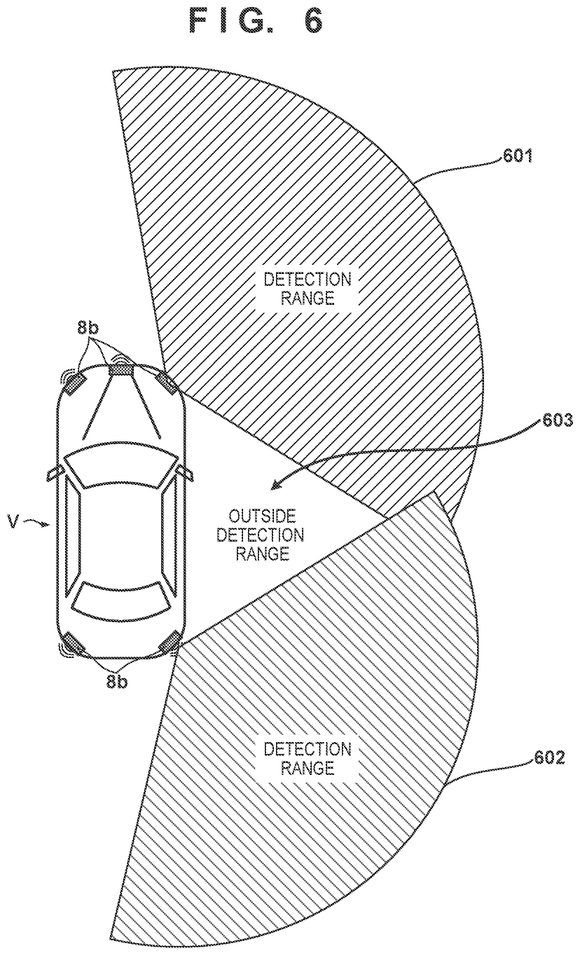

With reference to FIG. 6, a relationship between a detection range of the surroundings detection unit 8b, which is a sensor according to the present embodiment, and a region outside the detection range will be described. In FIG. 6, a detection range 601 indicates a range that can be detected by a surroundings detection unit 8b attached to a right front corner position of the vehicle V. Then, a detection range 602 indicates a range that can be detected by a surroundings detection unit 8b attached to a right rear corner position of the vehicle V. At least a part of the detection ranges of the detection range 601 and the detection range 602 overlaps. However, a region 603 outside the detection ranges (a region close to the vehicle with respect to an overlapping range), which cannot be detected by any of the surroundings detection units 8b, may occur. Note that although the region outside the detection range on the right side of the vehicle V has been described in an illustrated example, a similar region outside the detection range may occur on the left side.

<Lane Change Assistance Control>

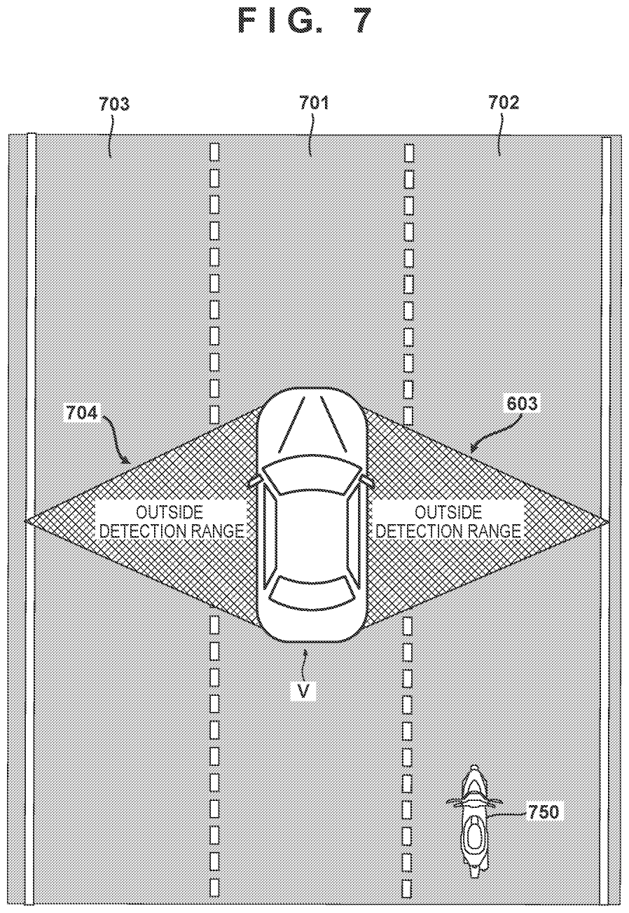

FIG. 7 is a diagram illustrating a relationship between another vehicle traveling in an adjacent lane of the vehicle V according to the embodiment and the region outside the detection range. The region 603 outside the detection ranges illustrated in FIG. 6 is illustrated on the right side of the vehicle V, and a region 704 outside the detection ranges is illustrated on the left side. The vehicle V is traveling in a travel lane 701, and another vehicle 750 is approaching from behind an adjacent lane 702. No other vehicle is traveling in an adjacent lane 703.

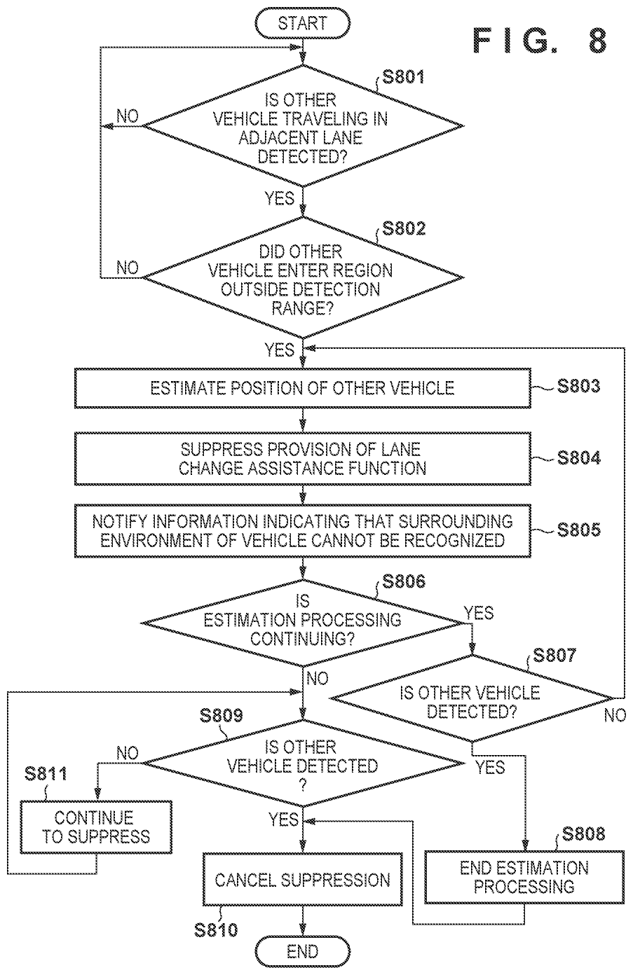

An example of lane change assistance control in such a situation will be described with reference to FIG. 8. FIG. 8 is a flowchart illustrating exemplary processing of the lane change assistance control performed by the ECU included in the controller 1. Note that this processing is processing that can be performed when the vehicle V is in the extended assist mode (mode 3) in which all of the ACC, the LKAS, the ALC, and the ALCA can be performed (when the high-precision map is used).

In S801, the ECU determines whether another vehicle traveling in the adjacent lane adjacent to the travel lane of the vehicle V is detected by a first sensor that is attached to a first position of the vehicle V and performs detection on a first range including a side region of the vehicle V or a second sensor that is attached to a second position of the vehicle V and performs detection on a second range including the side region.

In the example of FIG. 7, it is determined whether the other vehicle 750 traveling in the adjacent lane 702 adjacent to the travel lane 701 of the vehicle V is detected by the first sensor (the surroundings detection unit 8b) that is attached to the right front corner position of the vehicle V or the second sensor (the surroundings detection unit 8b) that is attached to the right rear corner position of the vehicle V. If this step is Yes, the process proceeds to S802. On the other hand, if this step is No, the process waits.

In S802, the ECU determines whether the other vehicle detected in S801 has entered the region outside the detection range. For example, when no other vehicle is detected by any of the first sensor and the second sensor, it can be determined that the other vehicle has entered the region outside the detection range. If this step is Yes, the process proceeds to S803. On the other hand, if this step is No, the process returns to S801 to continue detection processing.

In the example of FIG. 7, when the other vehicle 750 approaches the right side of the vehicle V and enters the region outside the detection range, it is not detected by the sensor, so that it can be determined that the other vehicle has entered the region outside the detection range.

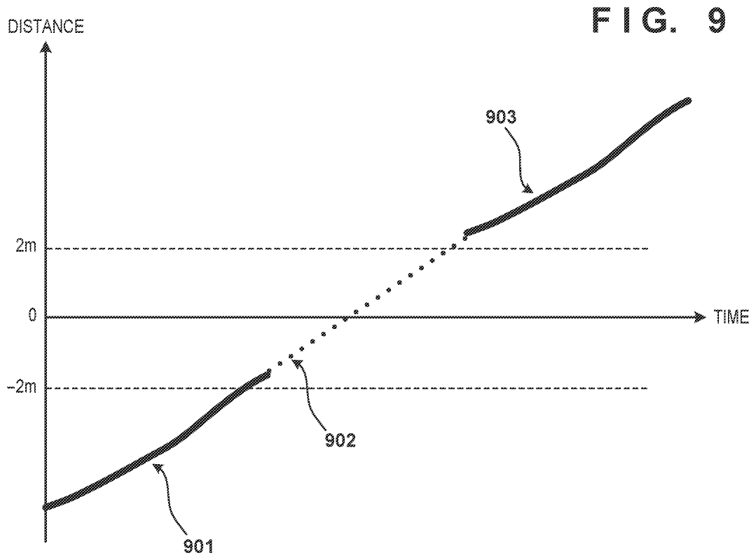

In S803, the ECU estimates a position of the other vehicle in the region outside the detection range. Here, an example of a method of estimating the position of the other vehicle according to the present embodiment will be described with reference to FIG. 9. The horizontal axis of the graph of FIG. 9 represents time (for example, seconds), and the vertical axis represents a relative distance (for example, meters) to the other vehicle with respect to the vehicle V in the traveling direction. When the distance is zero, it means that the other vehicle travels side by side right beside the vehicle V. When the distance is a negative value, it means that the other vehicle is traveling behind the vehicle V, and when the distance is a positive value, it means that the other vehicle is traveling ahead of the vehicle V. For example, as in the example of FIG. 7, when the other vehicle 750 approaches from behind the vehicle V, the relative distance in the lane direction between the vehicle V and the other vehicle 750 is calculated from the detection result of the second sensor (the surroundings detection unit 8b) that is attached to the right rear corner position of the vehicle V. The calculation result is plotted on a line 901. The other vehicle approaches the vehicle V as time passes. However, when the other vehicle enters the region 603 outside the detection range, the detection result is not obtained. Therefore, the line 901 is interrupted. At this time, the position of the other vehicle 750 is estimated by interpolating the plot by extrapolation processing. As an example, the extrapolation processing may be performed by determining a regression line of the line 901 and extending a straight line having a slope of the regression line. Note that as illustrated in FIG. 9, when the other vehicle 750 further moves forward and comes out in front of the region 603 outside the detection range, as indicated by a line 903, the relative distance between vehicle V and the other vehicle 750 can be calculated from the detection result of the first sensor (the surroundings detection unit 8b) that is attached to the right front corner position of the vehicle V.

In S804, the ECU suppresses provision of a lane change assistance function during performing estimation processing. In the example of FIG. 7, the lane change assistance function to the right side of the vehicle V is prohibited to be provided. Thus, when there is a possibility that the other vehicle is present in the region outside the detection range, it possible to suppress execution of the lane change in a direction of the other vehicle. Note that in the example of FIG. 7, since there is no other vehicle on the left side, the lane change assistance function to the left side of the vehicle V may continue to be provided. That is, the lane change assistance function may continue to be provided without suppressing the provision of the lane change assistance function in a direction opposite to a direction in which the estimation processing (extrapolation processing) is being performed. Thus, since excessive suppression can be prevented, it is possible to prevent convenience of a user from being lowered more than necessary.

In S805, the ECU uses the information output device 5 to notify information indicating that the other vehicle has entered the region outside the detection range and a surrounding environment of the vehicle V cannot be recognized. Thus, the occupant can easily recognize a current vehicle situation.

In S806, the ECU determines whether the estimation processing is continuing. When the estimation processing is continuing, the process proceeds to S807. On the other hand, when the estimation processing is ended, the process proceeds to S809. In the present embodiment, the estimation processing is performed for a predetermined period on the basis of the detection result of the first sensor or the second sensor. Then, when the predetermined period has elapsed, the estimation processing is ended. The ECU determines a length of the predetermined period on the basis of a predetermined length (for example, any fixed value in a range of 2.4 m to 2.9 m) in a direction along a lane in the region outside the detection range and a relative speed between the vehicle V and the other vehicle. In the example of FIG. 7, after the other vehicle 750 is detected by the second sensor, the relative speed between the vehicle V and the other vehicle 750 may be continuously calculated, and a minimum value of the relative speed may be used to calculate the predetermined period. That is, the length of the predetermined period may be determined on the basis of the length (for example, any fixed value in the range of 2.4 m to 2.9 m) in the direction along the lane in the region outside the detection range and the minimum value of the relative speed between vehicle V and the other vehicle. Alternatively, an average value of calculated relative speeds may be used instead of the minimum value.

In S807, the ECU determines whether the other vehicle has been detected again while the estimation processing is continuing. In the example of FIG. 7, it is determined whether the other vehicle 750 has moved forward, left the region 603 outside the detection range, and been detected again by the first sensor (the surroundings detection unit 8b). If this step is Yes, the process proceeds to S808. On the other hand, if this step is No, the process returns to S803 to continue the estimation processing.

In S808, the ECU ends the estimation processing. Even during the estimation processing, when the other vehicle is detected, the estimation processing is unnecessary, and thus the estimation processing is ended. Thus, a processing load can be reduced. Thereafter, the process proceeds to S810.

In S809, the ECU determines whether the other vehicle has been detected again after the estimation processing is ended. In the example of FIG. 7, after a lapse of a predetermined period from start of the estimation processing, it is determined whether the other vehicle 750 has moved forward, left the region 603 outside the detection range, and been detected again by the first sensor (the surroundings detection unit 8b). When this step is Yes, the process proceeds to S810. On the other hand, when this step is No, the process proceeds to S811.

In S810, the ECU cancels suppression of the provision of the lane change assistance function. End of the estimation processing means that the other vehicle can be detected by the sensor. Therefore, the suppression is canceled because the suppression is unnecessary.

In S811, the ECU continues to suppress provision of the lane change assistance function. Although the estimation processing has been ended, the other vehicle has not been detected yet, and thus the suppression is continued for safety. This is an end of a series of processing in FIG. 8.

As described above, in the present embodiment, when the other vehicle is present in the region outside the detection range of the sensor, the position of the other vehicle is estimated on the basis of the detection result when the other vehicle has been detected by the sensor, and the lane change assistance function is suppressed to be provided during the estimation processing.

Thus, even when the other vehicle cannot be detected, it is possible to estimate the position of the other vehicle, and further it is possible to improve safety by suppressing the provision of the lane change assistance function during estimation.

[Modifications]

In the above embodiment, an example of suppressing the provision of the lane change assistance function has been described. The lane change assistance function may be an automatic lane change function (ALC) that is based on a request from the control device CNT and is transitioned to a providable state in response to an operation of a driving assistance operation switch that is one of input devices 6 included in the vehicle V. Then, when the provision of the lane change assistance function continues to be suppressed after the end of the estimation processing (extrapolation processing), the ECU may transition the ALC from the providable state to a non-providable state. In this case, unless the driving assistance operation switch is operated again by the occupant, the ALC remains in the non-providable state. This makes it possible to further improve safety of providing the lane change assistance function.

In addition, the lane change may include a first lane change assistance function (ALCA) based on an automatic lane change instruction by a user operation, and a second lane change assistance function (ALC) based on the request from the control device. For example, the ECU may prohibit provision of the second lane change assistance function (ALC) during the estimation processing (during the extrapolation processing) and perform control to continue provision of the first lane change assistance function (ALCA). Thus, even in a state where the other vehicle cannot be detected by the sensor, it is possible to perform the first lane change assistance function (ALCA) based on the automatic lane change instruction by the user operation after the occupant visually confirms safety. Therefore, since it is possible to prevent provision of the function from being excessively suppressed, it is possible to prevent the convenience of the user from being excessively lowered.

In the above embodiment, the other vehicle traveling in the adjacent lane on the right side of the vehicle V has been described as an example, but the above processing can also be performed for another vehicle traveling on the left side of the vehicle V. Further, in the above embodiment, in FIG. 7, a scene where the other vehicle overtakes the vehicle V from behind has been described as an example, but the present invention is not limited to this example. The present invention is also applicable to a case where a speed of the other vehicle traveling in front of the adjacent lane of the vehicle V is slow, and the vehicle V gradually approaches the other vehicle while traveling in parallel, so that the other vehicle enters the region 603 outside the detection range. In this case, a detection result as indicated by the line 903 is obtained from a detection result of the first sensor (the surroundings detection unit 8b) that is attached to the right front corner position of the vehicle V as illustrated in FIG. 9, and the extrapolation processing (902) is performed on the basis of the detection result.

Further, in the above embodiment, the other vehicle is exemplified as a two-wheeled vehicle, but the present invention is not limited thereto. The present invention is also applicable to any other vehicle such as a three-wheeled vehicle, a four-wheeled vehicle, or a large vehicle. Further, the present invention is also applicable to an obstacle such as a falling object (other vehicles can also be included in the obstacle).

### Summary of Embodiment

The control device (CNT) according to a first aspect is a control device for controlling a vehicle (V) comprising: a first sensor (8b) that is attached to a first position (front right corner, for example) of a vehicle and detects a first range (601) including a side region of the vehicle; and a second sensor (8b) that is attached to a second position (rear right corner, for example) of the vehicle and detects a second range (602) including the side region, wherein
at least a part of detection ranges of the first sensor and the second sensor overlap each other, and a part of a region (603) closer to the vehicle than an overlapping range is outside the detection range, and
the vehicle comprises:
an estimation unit (1) configured to estimate a position of an obstacle (750) when the first sensor or the second sensor detects the obstacle in an adjacent lane (702, 703) adjacent to a travel lane (701) of the vehicle and the obstacle enters a region (603) outside the detection range; and
a control unit (1) configured to suppress provision of a lane change assistance function during estimation processing by the estimation unit.

Thus, it is possible to estimate the position of the obstacle (for example, the other vehicle) even when the obstacle cannot be detected, and further it is possible to improve the safety of the lane change assistance function by suppressing the provision of the lane change assistance function during estimation.

In the control device (CNT) according to a second aspect, the estimation unit is configured to estimate the position of the obstacle in the region (603) outside the detection range by performing extrapolation processing (902) on the basis of a detection result (901, 903) of the first sensor or the second sensor.

This makes it possible to estimate the position of the obstacle with a certain degree of accuracy even outside the detection range of the sensor.

In the control device (CNT) according to a third aspect, the estimation unit is configured to perform the extrapolation processing for a predetermined period on the basis of the detection result of the first sensor or the second sensor.

Thus, it is possible to perform the estimation processing (extrapolation processing) for a time required for the obstacle to leave the region outside the detection range according to the detection result of the sensor.

In the control device (CNT) according to a fourth aspect, the estimation unit is configured to determine the predetermined period on the basis of a predetermined length (for example, any fixed value in the range of 2.4 m to 2.9 m) in a direction along a lane in the region outside the detection range and a relative speed between the vehicle and the obstacle.

This makes it possible to accurately obtain a time during which the obstacle will be present in the region outside the detection range.

In the control device (CNT) according to a fifth aspect, the estimation unit is configured to determine the predetermined period on the basis of the length and a minimum value of the relative speed between the vehicle and the obstacle.

In this way, by using the minimum value of the relative speed, a margin can be given to a value of the predetermined period, so that it is possible to suppress the end of the estimation processing even though the obstacle is still present in the region outside the detection range.

In the control device (CNT) according to a sixth aspect, the estimation unit is configured to end the extrapolation processing when the obstacle is detected by the first sensor or the second sensor during the extrapolation processing (S806, 807, 808).

Thus, it is possible to prevent unnecessary estimation processing (extrapolation processing) from being continued when the obstacle has left the region outside the detection range earlier than expected.

In the control device (CNT) according to a seventh aspect, the control unit is configured to continue the provision without suppressing the provision of the lane change assistance function in a direction opposite to a direction in which the extrapolation processing is being performed.

Thus, since excessive suppression can be prevented, it is possible to prevent convenience of a user from being lowered more than necessary.

In the control device (CNT) according to an eighth aspect, the control unit is configured to continue to suppress the provision of the lane change assistance function when the obstacle is not detected by the first sensor or the second sensor in the adjacent lane after an end of the extrapolation processing (S806, 809, S811).

It is considered that there is a high possibility that the obstacle stays in the region outside the detection range because the obstacle should have left the region outside the detection range but is not detected yet. In such a case, by suppressing provision of the lane change assistance function, safety can be improved.

In the control device (CNT) according to a ninth aspect, the lane change assistance function is an automatic lane change function (ALC) that is transitioned to a providable state in response to an operation of a driving assistance operation switch (6, 6a) included in the vehicle and is based on a request from the control device, and
the control unit is configured to transition the lane change assistance function from a providable state to a non-providable state when the provision of the lane change assistance function continues to be suppressed after the end of the extrapolation processing.

In this way, since a standby state (an ALC use approval state) of the automatic lane change function (ALC) based on the request from the control device is turned off, it is necessary to turn on the standby state by operating the driving assistance operation switch (ALC switch) again. It is possible to call attention to the user through the user operation, and thus, it is possible to improve the safety.

In the control device (CNT) according to a tenth aspect, when the obstacle is detected by the first sensor or the second sensor in the adjacent lane after the end of the extrapolation processing, the control unit is configured to cancel suppression of the provision of the lane change assistance function (S806, 809, S810).

In this way, by resuming the provision of the lane change assistance function when the sensor can detect the obstacle again, it is possible to improve the safety of the lane change assistance function.

In the control device (CNT) according to an eleventh aspect, the lane change assistance function includes a first lane change assistance function (ALCA) based on an automatic lane change instruction by a user operation and a second lane change assistance function (ALC) based on a request from the control device, and
the control unit is configured to prohibit provision of the second lane change assistance function and continues provision of the first lane change assistance function during estimation processing by the estimation unit.

In this way, even during the estimation processing in which the obstacle is present in the region outside the detection range, the first lane change assistance function based on the automatic lane change instruction by the user operation can be performed. Thus when it can be recognized that the safety can be ensured by determination (visual confirmation) of the user, the automatic lane change based on an instruction of the user can be performed. For example, it is conceivable that after the obstacle enters the region outside the detection range in the adjacent lane, the obstacle does not directly move forward and leave the region but change lanes to an adjacent lane opposite to the vehicle, and the sensor loses the obstacle. In such a situation, if it is possible to confirm that there is no obstacle in the adjacent lane of the vehicle by visual confirmation of the user, the automatic lane change based on the automatic lane change instruction by the user operation can be performed. This makes it possible to further improve the convenience of the user.

The control device (CNT) according to a twelfth aspect, further comprising
a notification unit (1, 5) configured to notify information, wherein
the notification unit notifies information indicating that a surrounding environment of the vehicle cannot be recognized when provision of the lane change assistance function is suppressed by the control unit (S805).

Thus, the user can easily recognize the situation.

In the control device (CNT) according to a thirteenth aspect, the first position is a front corner (8b) of the vehicle, and the second position is a rear corner (8b) of the vehicle.

This makes it possible to detect a target present on the side of the vehicle.

The method for operating a control device (CNT) according to a fourteenth aspect is a method for operating a control device for controlling a vehicle (V) comprising: a first sensor (8b) that is attached to a first position of a vehicle and detects a first range (601) including a side region of the vehicle; and a second sensor (8b) that is attached to a second position of the vehicle and detects a second range (602) including the side region, wherein
at least a part of detection ranges of the first sensor and the second sensor overlap each other, and a part of a region (603) closer to the vehicle than an overlapping range is outside the detection range, and
the method for operating the control device comprises:
an estimation step (S803) of estimating a position of an obstacle (750) when the first sensor or the second sensor detects the obstacle in an adjacent lane (702, 703) adjacent to a travel lane (701) of the vehicle and the obstacle enters a region outside the detection range; and
a control step (S804) of suppressing provision of a lane change assistance function during estimation processing in the estimation step.

Thus, it is possible to estimate the position of the obstacle even when the obstacle cannot be detected, and further it is possible to improve the safety of the lane change assistance function by suppressing the provision of the lane change assistance function during estimation.

The storage medium according to a fifteenth aspect is a non-transitory computer-readable storage medium storing a program for causing a computer to function as the control device according to any one of the first aspect to the thirteenth aspect.

Thus, processing of the control device can be implemented by the non-transitory computer-readable storage medium.

According to the present invention, it is possible to improve the safety of the lane change assistance function.

The invention is not limited to the foregoing embodiments, and various variations/changes are possible within the spirit of the invention.

What is claimed is:

1. A control device for controlling a vehicle comprising: a first sensor that is attached to a first position of a vehicle and detects a first range including a side region of the vehicle; and a second sensor that is attached to a second position of the vehicle and detects a second range including the side region, wherein
at least a part of detection ranges of the first sensor and the second sensor overlap each other, and a part of a region closer to the vehicle than an overlapping range is outside the detection range, and
the vehicle comprises:
an estimation unit configured to estimate a position of an obstacle when the first sensor or the second sensor detects the obstacle in an adjacent lane adjacent to a travel lane of the vehicle and the obstacle enters a region outside the detection range; and
a control unit configured to suppress provision of a lane change assistance function during estimation processing by the estimation unit.

2. The control device according to claim 1, wherein the estimation unit is configured to estimate the position of the obstacle in the region outside the detection range by performing extrapolation processing on the basis of a detection result of the first sensor or the second sensor.

3. The control device according to claim 2, wherein the estimation unit is configured to perform the extrapolation processing for a predetermined period on the basis of the detection result of the first sensor or the second sensor.

4. The control device according to claim 3, wherein the estimation unit is configured to determine the predetermined period on the basis of a predetermined length in a direction along a lane in the region outside the detection range and a relative speed between the vehicle and the obstacle.

5. The control device according to claim 4, wherein the estimation unit is configured to determine the predetermined period on the basis of the length and a minimum value of the relative speed between the vehicle and the obstacle.

6. The control device according to claim 2, wherein the estimation unit is configured to end the extrapolation processing when the obstacle is detected by the first sensor or the second sensor during the extrapolation processing.

7. The control device according to claim 2, wherein the control unit is configured to continue the provision without suppressing the provision of the lane change assistance function in a direction opposite to a direction in which the extrapolation processing is being performed.

8. The control device according to claim 2, wherein the control unit is configured to continue to suppress the provision of the lane change assistance function when the obstacle is not detected by the first sensor or the second sensor in the adjacent lane after an end of the extrapolation processing.

9. The control device according to claim 8, wherein the lane change assistance function is an automatic lane change function that is transitioned to a providable state in response to an operation of a driving assistance operation switch included in the vehicle and is based on a request from the control device, and
the control unit is configured to transition the lane change assistance function from a providable state to a non-providable state when the provision of the lane change assistance function continues to be suppressed after the end of the extrapolation processing.

10. The control device according to claim 2, wherein when the obstacle is detected by the first sensor or the second sensor in the adjacent lane after the end of the extrapolation processing, the control unit is configured to cancel suppression of the provision of the lane change assistance function.

11. The control device according to claim 1, wherein the lane change assistance function includes a first lane change assistance function based on an automatic lane change instruction by a user operation and a second lane change assistance function based on a request from the control device, and
the control unit is configured to prohibit provision of the second lane change assistance function and continues provision of the first lane change assistance function during estimation processing by the estimation unit.

12. The control device according to claim 1, further comprising
a notification unit configured to notify information, wherein
the notification unit notifies information indicating that a surrounding environment of the vehicle cannot be recognized when provision of the lane change assistance function is suppressed by the control unit.

13. The control device according to claim 1, wherein the first position is a front corner of the vehicle, and the second position is a rear corner of the vehicle.

14. A method for operating a control device for controlling a vehicle comprising: a first sensor that is attached to a first position of a vehicle and detects a first range including a side region of the vehicle; and a second sensor that is attached to a second position of the vehicle and detects a second range including the side region, wherein
at least a part of detection ranges of the first sensor and the second sensor overlap each other, and a part of a region closer to the vehicle than an overlapping range is outside the detection range, and
the method for operating the control device comprises:
an estimation step of estimating a position of an obstacle when the first sensor or the second sensor detects the obstacle in an adjacent lane adjacent to a travel lane of the vehicle and the obstacle enters a region outside the detection range; and
a control step of suppressing provision of a lane change assistance function during estimation processing in the estimation step.

15. A non-transitory computer-readable storage medium storing a program for causing a computer to function as the control device according to claim 1.
